(19) United States
(12) Patent Application Publication
(10) Pub. No.: US 2026/0066385 A1
(43) Pub. Date: Mar. 5, 2026

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/240,366

(22) Filed: Jun. 17, 2025

(30) Foreign Application Priority Data
Aug. 29, 2024 (JP) 2024-147186

(51) Int. Cl. H01M 10/6554; B60L 50/60; B60L 50/64; H01M 10/613; H01M 10/625; H01M 10/647; H01M 10/653; H01M 10/6568; H01M 50/209; H01M 50/325

(52) U.S. Cl. CPC H01M 10/6554; H01M 10/613; H01M 10/625; H01M 10/647; H01M 10/653; H01M 10/6568; H01M 50/209; H01M 50/325; B60L 50/64; B60L 50/66; H01M 2220/20

(57) ABSTRACT

A power storage device includes a plurality of power storage cells, a first heat conduction member, a second heat conduction member, a first connecting member, and a second connecting member. The first heat conduction member faces a portion on one side of a safety valve in a second direction. The second heat conduction member faces a portion on another side of the safety valve in the second direction. The first connecting member is provided between the valve mounting surface of each power storage cell disposed in odd-numbered positions from one end side power storage cell to another end side power storage cell, and the first heat conduction member. The second connecting member is provided between the valve mounting surface of each power storage cell disposed in even-numbered positions from the one end side power storage cell to the other end side power storage cell, and the second heat conduction member.

### CROSS-REFERENCE TO RELATED APPLICATION

This application claims priority to Japanese Patent Application No. 2024-147186 filed on Aug. 29, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

For example, Japanese Unexamined Patent Application Publication (Translation of PCT Application) No. 2022-525014 (JP 2022-525014 A) discloses a power battery pack including a plurality of unit cells and a housing device. An external terminal and an explosion-proof valve are provided on the side surface of a case of each unit cell.

### SUMMARY

In such a power storage device described in JP 2022-525014 A, there is room for improvement in resistance to heat transfer between adjacent power storage cells.

An object of the present disclosure is to provide a power storage device that is able to suppress heat transfer between adjacent power storage cells.

A power storage device according to an aspect of the present disclosure includes: a plurality of power storage cells arranged in a first direction; a first heat conduction member with a shape extending from one end side power storage cell disposed at an end portion on one side in the first direction among the power storage cells to another end side power storage cell disposed at an end portion on another side in the first direction among the power storage cells; a second heat conduction member with a shape extending from the one end side power storage cell to the other end side power storage cell; a first connecting member connecting the first heat conduction member and the power storage cells; and a second connecting member connecting the second heat conduction member and the power storage cells. Each of the power storage cells is provided with a cell case including a valve mounting surface on which a safety valve is provided. The first heat conduction member faces a portion of the valve mounting surface on one side of the safety valve in a second direction orthogonal to both the first direction and an up-down direction. The second heat conduction member faces a portion of the valve mounting surface on another side of the safety valve in the second direction. The first connecting member is provided between the valve mounting surface of each of power storage cells disposed in odd-numbered positions among the power storage cells from the one end side power storage cell to the other end side power storage cell, and the first heat conduction member. The second connecting member is provided between the valve mounting surface of each of power storage cells disposed in even-numbered positions among the power storage cells from the one end side power storage cell to the other end side power storage cell, and the second heat conduction member.

According to the present disclosure, it is possible to provide a power storage device that is able to suppress heat transfer between adjacent power storage cells.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle including a power storage device according to an embodiment of the present disclosure;

FIG. 2 is a perspective view schematically illustrating the power storage device, a frame member, a front component member, and a rear component member;

FIG. 3 is a sectional view taken along line III-III in FIG. 2;

FIG. 4 is a cross-sectional view taken along line IV-IV in FIG. 3;

FIG. 5 is a bottom view of a power storage stack and each heat conduction member; and

FIG. 6 is a bottom view of a modification of the power storage stack and each heat conduction member.

### DETAILED DESCRIPTION OF EMBODIMENTS

An embodiment of the present disclosure will be described with reference to the drawings. In the drawings referred to below, the same or corresponding members are given the same numbers.

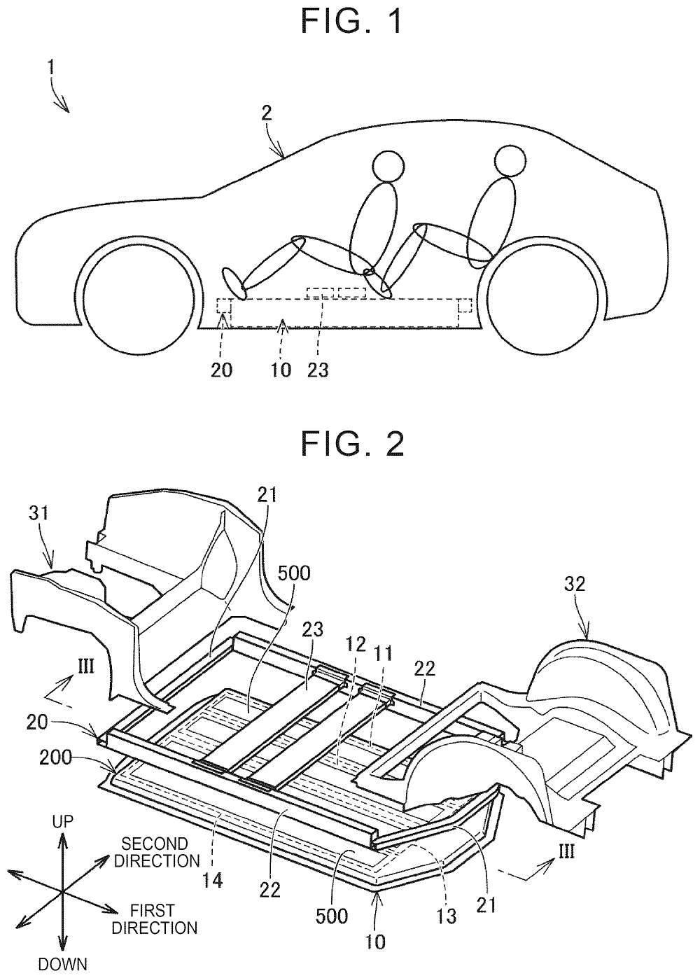

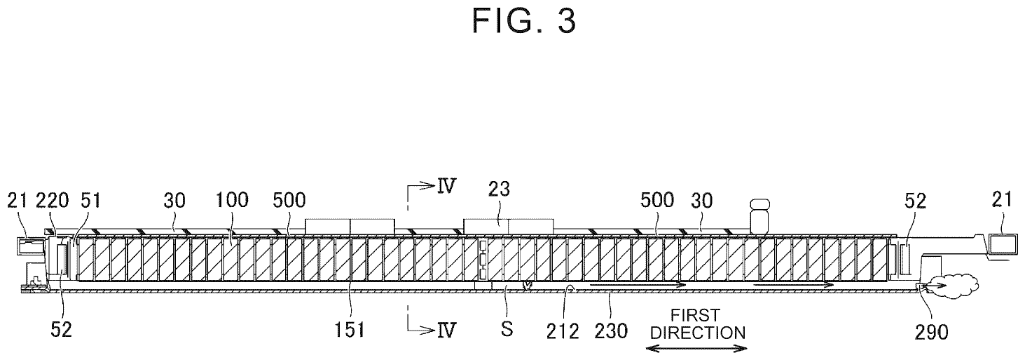

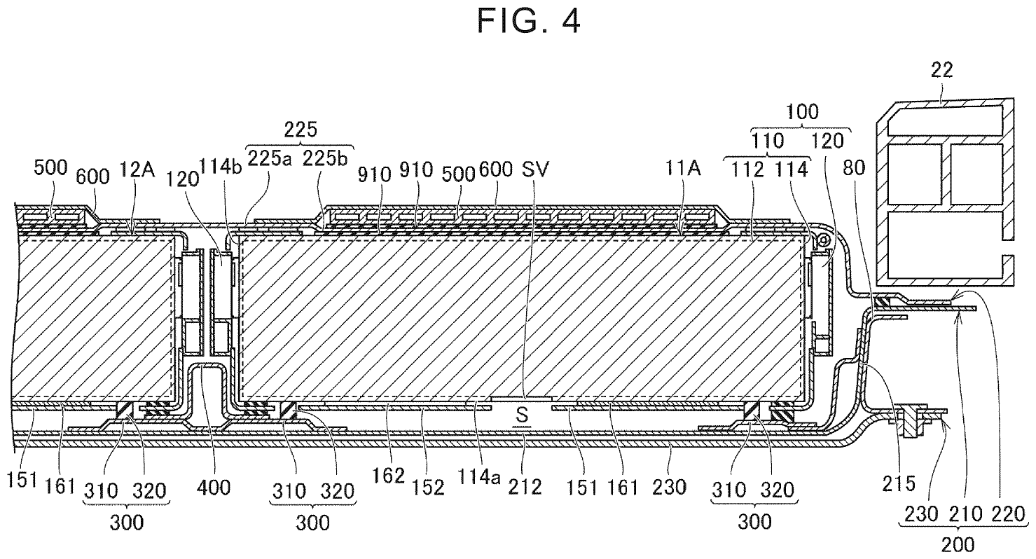

FIG. 1 is a diagram schematically illustrating a vehicle including a power storage device according to an embodiment of the present disclosure. FIG. 2 is a perspective view schematically illustrating the power storage device, a frame member, and a vehicle frame. FIG. 3 is a sectional view taken along line III-III in FIG. 2. FIG. 4 is a cross-sectional view taken along line IV-IV in FIG. 3.

As shown in FIG. 1, a vehicle 1 includes a vehicle body 2 and a power storage device 10. Examples of the vehicle 1 include a hybrid electric vehicle, a plug-in hybrid electric vehicle, a battery electric vehicle, and the like.

As shown in FIGS. 1 and 2, the vehicle body 2 includes a frame member 20, a front component member 31, and a rear component member 32. The frame member 20 is disposed at the bottom portion of the vehicle body 2. The frame member 20 has a pair of first frames 21, a pair of second frames 22, and a cross frame 23.

The first frames 21 face each other in the first direction. The first direction may be a direction parallel to the front-rear direction of the vehicle 1. In the example shown in FIG. 2, the first frame 21 disposed at the front has a shape extending along the second direction orthogonal to both the first direction and the up-down direction. The first frame 21 disposed at the rear extends in the second direction and has a shape that protrudes rearward. The second direction may be a direction parallel to the right-left direction (width direction) of the vehicle 1.

The second frames 22 face each other in the second direction. Each of the second frames 22 has a shape extending along the first direction. The end portions of each second frame 22 in the first direction are connected to the first frames 21. The second frames 22 are formed into a substantially rectangular tubular shape, and surround the power storage device 10 together with the first frames 21.

The cross frame 23 is disposed between the first frames 21 and connects the second frames 22 to each other. The cross frame 23 constitutes, for example, a seat cross.

The front component member 31 is connected to the front portion of the frame member 20. The rear component member 32 is connected to the rear portion of the frame member 20. Each of the component members 31, 32 may be formed by aluminum die casting.

The power storage device 10 is attached to the frame member 20. As shown in FIGS. 2 and 3, the power storage device 10 is disposed below the cross frame 23. As shown in FIGS. 1 to 4, the power storage device 10 includes four power storage stacks 11 to 14, first heat conduction members 151, second heat conduction members 152, first connecting members 161, second connecting members 162, a housing 200, structural members 300, reinforcing portions 400, coolers 500, and covering members 600. The number of the power storage stacks is not limited to four. The covering members 600 are omitted in FIG. 2.

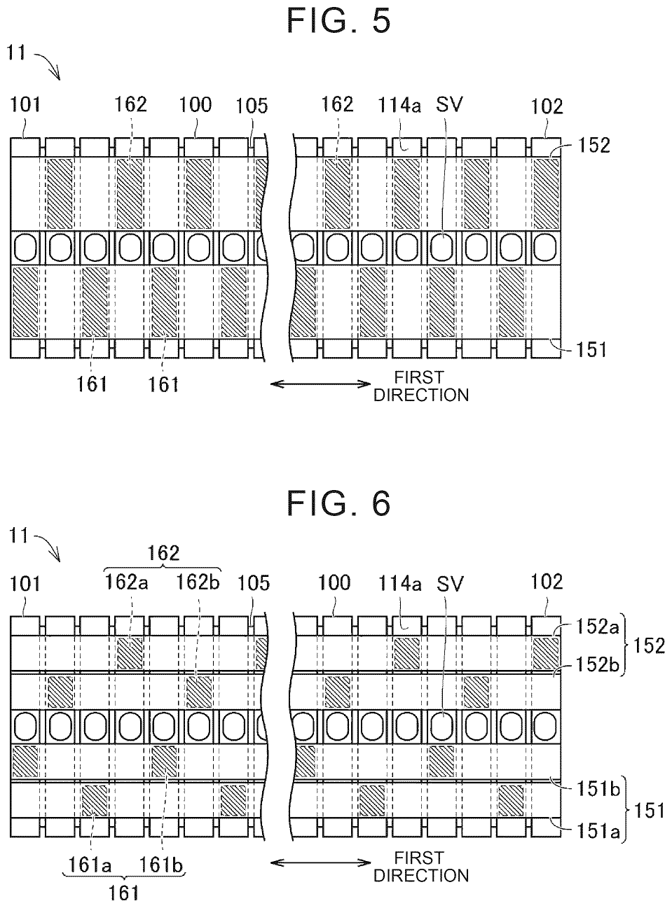

Each of the power storage stacks 11 to 14 includes at least one power storage cell 100. In the present embodiment, each of the power storage stacks 11 to 14 includes a power storage cell group including a plurality of (for example, 50) power storage cells 100 arranged side by side along the first direction. Each of the power storage stacks 11 to 14 may further include a plurality of spacers 105 (see FIG. 5). Each spacer 105 is disposed between a pair of adjacent power storage cells 100 in the power storage cell group. Each of the power storage stacks 11 to 14 is formed in a rectangular parallelepiped shape that is elongated in the first direction. As shown in FIG. 2, the four power storage stacks 11 to 14 are arranged side by side along the second direction.

As shown in FIG. 3, a pair of end plates 51 is provided such that one end plate 51 is provided on each side of the plurality of power storage cells 100 and the end plates 51 sandwich the power storage cells 100 from both sides in the first direction. A monitoring unit (smart battery management) 52 is disposed on the outside of each end plate 51 in the first direction.

As shown in FIG. 4, each power storage cell 100 has a cell body 110 and a pair of external terminals 120. FIG. 4 illustrates the power storage cell 100 included in a first power storage cell group 11A of the first power storage stack 11 and a part of the power storage cell 100 included in a second power storage cell group 12A of the second power storage stack 12.

The cell body 110 includes an electrode body 112 and a cell case 114. The thickness direction of the cell body 110 corresponds to the first direction. The width direction of the cell body 110 (the direction orthogonal to both the thickness direction and the up-down direction) corresponds to the second direction.

The electrode body 112 may be made up of a wound body in which a positive electrode sheet and a negative electrode sheet are wound with a separator interposed therebetween, or may be made up of a laminate in which a positive electrode sheet and a negative electrode sheet are stacked with a separator interposed therebetween. The electrode body 112 is formed in a shape that is elongated in the second direction.

The cell case 114 houses the electrode body 112. The cell case 114 is formed in a rectangular parallelepiped shape. The cell case 114 is made of a metal such as aluminum. The cell case 114 includes a valve mounting surface 114a and terminal mounting surfaces 114b.

A safety valve SV is provided on the valve mounting surface 114a. In the present embodiment, the valve mounting surface 114a is made up of the lower surface of the cell case 114. However, the valve mounting surface 114a may be made up of the upper surface of the cell case 114.

The external terminal 120 is provided on the terminal mounting surface 114b. In the present embodiment, the terminal mounting surface 114b is made up of the side surface of the cell case 114 in the second direction. That is, each external terminal 120 protrudes in the second direction from the side surface of the cell case 114 in the second direction. One of the external terminals 120 protrudes from the side surface of the cell case 114 on one side in the second direction. The other one of the external terminals 120 protrudes from the side surface of the cell case 114 on the other side in the second direction.

As shown in FIG. 5, the first heat conduction member 151 has a shape that extends from one end side power storage cell 101 to another end side power storage cell 102. The one end side power storage cell 101 is the power storage cell 100 that is disposed in the end portion on one side of the power storage cells 100 in the first direction. The other end side power storage cell 102 is the power storage cell 100 that is disposed in the end portion on the other side of the power storage cells 100 in the first direction.

The first heat conduction member 151 faces a portion of the valve mounting surface 114a on one side of the safety valve SV in the second direction. The first heat conduction member 151 may be formed in a flat plate shape. The first heat conduction member 151 is made of a material having thermal conductivity. The first heat conduction member 151 is made of aluminum oxide or the like. The first heat conduction member 151 does not overlap with the safety valve SV in the up-down direction.

The second heat conduction member 152 has a shape that extends from the one end side power storage cell 101 to the other end side power storage cell 102. The second heat conduction member 152 faces a portion of the valve mounting surface 114a on the other side of the safety valve SV in the second direction. The second heat conduction member 152 may be formed in a flat plate shape. The second heat conduction member 152 is made of a material having thermal conductivity. The second heat conduction member 152 is made of aluminum oxide or the like. The second heat conduction member 152 does not overlap with the safety valve SV in the up-down direction.

The first connecting member 161 connects the first heat conduction member 151 and the power storage cells 100. The first connecting member 161 is provided between the valve mounting surface 114a of each power storage cell 100 disposed in odd-numbered positions among the power storage cells 100 from the one end side power storage cell 101 to the other end side power storage cell 102, and the first heat conduction member 151. The first connecting members 161 are preferably made of a thermally conductive adhesive. In FIG. 5, each of the first connecting members 161 is indicated by oblique lines.

The second connecting members 162 connect the second heat conduction member 152 and the power storage cells 100. The second connecting member 162 is provided between the valve mounting surface 114a of each power storage cell 100 disposed in even-numbered positions among the power storage cells 100 from the one end side power storage cell 101 to the other end side power storage cell 102, and the second heat conduction member 152. The second connecting members 162 are preferably made of a thermally conductive adhesive. In FIG. 5, each of the second connecting members 162 is indicated by oblique lines.

The housing 200 houses the power storage cells 100. In the present embodiment, the housing 200 houses the four power storage stacks 11 to 14. As shown in FIG. 4, the housing 200 has a lower case 210, an upper cover 220, and a panel member 230.

The lower case 210 is open upward. The lower case 210 has a bottom wall 212 and a peripheral wall 215.

The bottom wall 212 is located below each of the power storage stacks 11 to 14. The bottom wall 212 may be formed in a flat plate shape.

The peripheral wall 215 stands up from the peripheral edge portion of the bottom wall 212. The peripheral wall 215 has a shape that surrounds the bottom portions of the power storage stacks 11 to 14 collectively.

The upper cover 220 is disposed above the power storage cells 100. In the present embodiment, the upper cover 220 is disposed above the four power storage stacks 11 to 14. The upper cover 220 houses, together with the lower case 210, the four power storage stacks 11 to 14 in a sealed state. The peripheral edge portion of the upper cover 220 is connected to the peripheral edge portion of the lower case 210 by bolts or the like via a sealing member.

As shown in FIG. 4, the upper cover 220 has an upper wall 225. The upper wall 225 is provided above at least one power storage cell 100. In the present embodiment, the upper wall 225 is provided above the four power storage stacks 11 to 14. The upper wall 225 has a top portion 225a and four recesses 225b.

The top portion 225a is formed flat. The top portion 225a overlaps in the up-down direction with the end portions of each power storage stack in the second direction.

Each recess 225b is recessed downward from the top portion 225a. Each recess 225b is formed flat. Each recess 225b is formed above the center portion of each of the power storage stacks 11 to 14 in the second direction. As shown in FIG. 4, the length of each recess 225b in the second direction is shorter than the length of the power storage cell 100 in the second direction. Each recess 225b is in contact with the upper surface of the cell case 114 via a thermally conductive adhesive 910.

The panel member 230 is provided below the lower case 210. The panel member 230 has a function of protecting the lower case 210. The panel member 230 may be formed in a flat plate shape. As shown in FIG. 4, the peripheral edge portion of the panel member 230 is connected to the lower case 210 via a bracket 80.

The structural members 300 are provided on the bottom wall 212. Each of the power storage stacks 11 to 14, the bottom wall 212, and the structural members 300 define a space S below each of the power storage stacks 11 to 14. In the present embodiment, the structural members 300 define, together with each of the power storage stacks 11 to 14 and the bottom wall 212, the space S below each of the power storage stacks 11 to 14. That is, in the present embodiment, four spaces S are formed inside the housing 200.

As shown in FIG. 3, each space S extends in the first direction. Each space S functions as a smoke exhaust path (hereinafter referred to as “smoke exhaust path S”). The smoke exhaust path S is a path for discharging gas discharged from the safety valve SV of the power storage cell 100 to the outside of the housing 200. Each smoke exhaust path S is connected to a common space within the housing 200 at an end portion of the smoke exhaust path S in the first direction.

As shown in FIG. 3, an explosion-proof valve 290 is provided on the peripheral wall 215 at a portion facing the smoke exhaust path S in the first direction. The explosion-proof valve 290 is provided in the common space within the housing 200. The explosion-proof valve 290 releases pressure in the housing 200. The explosion-proof valve 290 opens when the pressure inside the housing 200 reaches or exceeds a reference value. The explosion-proof valve 290 is made up of a check valve. As shown in FIG. 3, when gas is discharged from any of the power storage cells 100, the gas spreads in the first direction through the smoke exhaust path S and is discharged to the outside of the housing 200 through the explosion-proof valve 290.

As shown in FIG. 4, the structural members 300 contact both end portions of the valve mounting surface 114a of each power storage cell 100 in the second direction and the bottom wall 212. The structural members 300 may support each of the power storage stacks 11 to 14. In the present embodiment, the structural member 300 has a base portion 310 and a sealing portion 320.

A pair of the base portions 310 is connected to the bottom wall 212. The base portions 310 are disposed at positions facing each other in the second direction (width direction) with the safety valve SV therebetween.

Each of the sealing portions 320 is in contact with the valve mounting surface 114a of the power storage cell 100 and a corresponding one of the base portions 310. The sealing portions 320 may be made of urethane resin. The sealing portions 320 extend in the first direction. The inner surface of each of the sealing portions 320 in the second direction is in contact with the smoke exhaust path S.

The reinforcing portions 400 reinforce the bottom wall 212. The reinforcing portion 400 is disposed between a pair of power storage stacks (a pair of power storage cell groups) adjacent to each other in the second direction. Specifically, as shown in FIG. 4, the reinforcing portion 400 is disposed between a pair of the cell bodies 110 adjacent to each other in the second direction, and below a pair of the external terminals 120 adjacent to each other in the second direction. The reinforcing portion 400 overlaps in the up-down direction with both of the external terminals 120 facing each other in the second direction.

The reinforcing portions 400 extend along the first direction. The end portions of the reinforcing portion 400 in the first direction may be in contact with the peripheral wall 215 or may be spaced apart from the peripheral wall 215. The reinforcing portion 400 is connected to the base portions 310. In the present embodiment, the reinforcing portion 400 is connected to a raised portion 312 (not shown) of each of the base portions 310 by welding or the like. That is, the reinforcing portion 400 functions as a connecting portion that connects the structural member 300 provided below one power storage stack of the pair of adjacent power storage stacks (e.g., the first power storage stack 11 and the second power storage stack 12) to the structural member 300 provided below the other power storage stack of the pair of power storage stacks. The reinforcing portions 400 have a shape that protrudes upward from the base portion 310.

The cooler 500 cools at least one power storage cell 100. A cooling medium (such as water) flows through the cooler 500. As shown in FIGS. 2 to 4, the coolers 500 are provided on the upper wall 225. More specifically, the coolers 500 are provided in the recesses 225b of the upper wall 225.

Each of the coolers 500 is in thermal contact with at least one power storage cell 100 via the upper wall 225. In the present embodiment, the thermally conductive adhesive 910 extending along the first direction is provided between the cooler 500 and the recess 225b. That is, in the present embodiment, the cooler 500 is in thermal contact with each of the power storage stacks 11 to 14 via the upper wall 225 and the thermally conductive adhesive 910. Thermal contact includes a mode in which the cooler 500 contacts the power storage cell 100 only via the upper wall 225, and a mode in which the cooler 500 indirectly contacts the power storage cell 100 via a thermally conductive member (such as an adhesive or a fixing member).

The covering members 600 cover the coolers 500. The covering members 600 may be formed of a material having thermal insulation properties. The covering members 600 are omitted in FIGS. 2 and 3.

The coolers 500 and the covering members 600 form at least a part of a floor portion 30 (see FIG. 3) of a vehicle cabin. The floor portion 30 of the vehicle cabin may include, in addition to the coolers 500 and the covering members 600, floor component members (such as a cushioning member, carpet, etc.) disposed on the covering members 600. The floor component members are omitted in FIGS. 2 and 4.

In the power storage device 10 described above, when gas is discharged downward from the safety valve SV due to a short circuit or the like in any of the power storage cells 100, the gas flows into the smoke exhaust path S. Then, the gas that has flowed into the smoke exhaust path S spreads in the first direction and is discharged from the housing 200 through the explosion-proof valve 290 as shown in FIG. 3. This restrains the contents (so-called debris) of the power storage cell 100 included in the gas from adhering to the external terminal 120 of the power storage cell 100 and the like.

Further, in the power storage device 10, heat transfer paths are formed that connects each of the power storage cells 100 disposed alternately among the power storage cells 100 included in each of the power storage stacks 11 to 14, thereby suppressing heat transfer between adjacent power storage cells 100.

In addition, since the first heat conduction member 151 and the second heat conduction member 152 are arranged below each of the power storage stacks 11 to 14, the bottom wall 212 is restrained from colliding with the valve mounting surfaces 114a of the cell cases 114 when a load acts on the power storage device 10 from below. Therefore, the shape of the safety valves SV is effectively maintained.

In the above embodiment, as shown in FIG. 6, the first heat conduction member 151 may include a first outer heat conduction element 151a and a first inner heat conduction element 151b, and the second heat conduction member 152 may include a second outer heat conduction element 152a and a second inner heat conduction element 152b.

The first outer heat conduction element 151a is disposed on an outer side in the second direction. The first outer heat conduction element 151a is formed in a flat plate shape.

The first inner heat conduction element 151b is disposed on an inner side in the second direction. The first inner heat conduction element 151b is disposed between the first outer heat conduction element 151a and each safety valve SV. The first inner heat conduction element 151b is spaced apart from the first outer heat conduction element 151a in the second direction.

The second outer heat conduction element 152a is disposed on an outer side in the second direction. The second outer heat conduction element 152a is formed in a flat plate shape.

The second inner heat conduction element 152b is disposed on an inner side in the second direction. The second inner heat conduction element 152b is disposed between the second outer heat conduction element 152a and each safety valve SV. The second inner heat conduction element 152b is spaced apart from the second outer heat conduction element 152a in the second direction.

The first connecting member 161 may include a first outer connecting element 161a and a first inner connecting element 161b, and the second connecting member 162 may include a second outer connecting element 162a and a second inner connecting element 162b.

The first outer connecting element 161a is provided between every fourth power storage cell 100 arranged in the first direction and the first outer heat conduction element 151a.

The first inner connecting element 161b is provided between every fourth power storage cell 100 arranged in the first direction and the first inner heat conduction element 151b. The every fourth power storage cell 100 is other than the power storage cells 100 that are in contact with the first outer connecting element 161a among the power storage cells 100.

The second outer connecting element 162a is provided between every fourth power storage cell 100 arranged in the first direction and the second outer heat conduction element 152a.

The second inner connecting element 162b is provided between every fourth power storage cell 100 arranged in the first direction and the second inner heat conduction element 152b. The every fourth power storage cell 100 is other than the power storage cells 100 that are in contact with the second outer connecting element 162a among the power storage cells 100.

It will be understood by a person skilled in the art that the exemplary embodiments described above are examples of the following aspects.

### First Aspect

A power storage device includes: a plurality of power storage cells arranged in a first direction; a first heat conduction member with a shape extending from one end side power storage cell disposed at an end portion on one side in the first direction among the power storage cells to another end side power storage cell disposed at an end portion on another side in the first direction among the power storage cells; a second heat conduction member with a shape extending from the one end side power storage cell to the other end side power storage cell; a first connecting member connecting the first heat conduction member and the power storage cells; and a second connecting member connecting the second heat conduction member and the power storage cells. Each of the power storage cells is provided with a cell case including a valve mounting surface on which a safety valve is provided. The first heat conduction member faces a portion of the valve mounting surface on one side of the safety valve in a second direction orthogonal to both the first direction and an up-down direction. The second heat conduction member faces a portion of the valve mounting surface on another side of the safety valve in the second direction. The first connecting member is provided between the valve mounting surface of each of power storage cells disposed in odd-numbered positions among the power storage cells from the one end side power storage cell to the other end side power storage cell, and the first heat conduction member. The second connecting member is provided between the valve mounting surface of each of power storage cells disposed in even-numbered positions among the power storage cells from the one end side power storage cell to the other end side power storage cell, and the second heat conduction member.

In the power storage device, heat transfer paths are formed that connects each of the power storage cells disposed alternately among the power storage cells, thereby suppressing heat transfer between adjacent power storage cells.

### Second Aspect

In the power storage device according to the first aspect, the first heat conduction member includes a first outer heat conduction element, and a first inner heat conduction element that is disposed between the first outer heat conduction element and each of the safety valves. The second heat conduction member includes a second outer heat conduction element, and a second inner heat conduction element that is disposed between the second outer heat conduction element and each of the safety valves. The first connecting member includes a first outer connecting element that is provided between every fourth power storage cell arranged in the first direction and the first outer heat conduction element, and a first inner connecting element that is provided between every fourth power storage cell arranged in the first direction and the first inner heat conduction element, the every fourth power storage cell being other than the power storage cells contacting the first outer connecting element among the power storage cells. The second connecting member includes a second outer connecting element that is provided between every fourth power storage cell arranged in the first direction and the second outer heat conduction element, and a second inner connecting element that is provided between every fourth power storage cell in the first direction and the second inner heat conduction element, the every fourth power storage cell being other than the power storage cells contacting the second outer connecting element among the power storage cells.

### Third Aspect

The power storage device according to the first aspect or the second aspect further includes a cooler that cools the power storage cells. The valve mounting surface is made up of a lower surface of the cell case, and the cooler is disposed above the cell case.

In this aspect, since each of the power storage cells is cooled by the cooler, the transfer of heat between the power storage cells is more effectively suppressed.

### Fourth Aspect

The power storage device according to any one of the first aspect to the third aspect, in which the first connecting member and the second connecting member are made of a thermally conductive adhesive.

The embodiment disclosed this time should be considered to be illustrative in all respects and not restrictive. The scope of the present disclosure is indicated by the claims rather than the description of the embodiment described above, and all changes within the meaning and scope equivalent to the claims are included.

What is claimed is:

1. A power storage device comprising:
a plurality of power storage cells arranged in a first direction;
a first heat conduction member with a shape extending from one end side power storage cell disposed at an end portion on one side in the first direction among the power storage cells to another end side power storage cell disposed at an end portion on another side in the first direction among the power storage cells;
a second heat conduction member with a shape extending from the one end side power storage cell to the other end side power storage cell;
a first connecting member connecting the first heat conduction member and the power storage cells; and
a second connecting member connecting the second heat conduction member and the power storage cells, wherein each of the power storage cells is provided with a cell case including a valve mounting surface on which a safety valve is provided,
the first heat conduction member faces a portion of the valve mounting surface on one side of the safety valve in a second direction orthogonal to both the first direction and an up-down direction,
the second heat conduction member faces a portion of the valve mounting surface on another side of the safety valve in the second direction,
the first connecting member is provided between the valve mounting surface of each of power storage cells disposed in odd-numbered positions among the power storage cells from the one end side power storage cell to the other end side power storage cell, and the first heat conduction member, and
the second connecting member is provided between the valve mounting surface of each of power storage cells disposed in even-numbered positions among the power storage cells from the one end side power storage cell to the other end side power storage cell, and the second heat conduction member.

2. The power storage device according to claim 1, wherein:
the first heat conduction member includes
a first outer heat conduction element, and
a first inner heat conduction element that is disposed between the first outer heat conduction element and each of the safety valves;
the second heat conduction member includes
a second outer heat conduction element, and
a second inner heat conduction element that is disposed between the second outer heat conduction element and each of the safety valves;
the first connecting member includes
a first outer connecting element that is provided between every fourth power storage cell arranged in the first direction and the first outer heat conduction element, and
a first inner connecting element that is provided between every fourth power storage cell arranged in the first direction and the first inner heat conduction element, the every fourth power storage cell being other than the power storage cells contacting the first outer connecting element among the power storage cells; and
the second connecting member includes
a second outer connecting element that is provided between every fourth power storage cell arranged in the first direction and the second outer heat conduction element, and
a second inner connecting element that is provided between every fourth power storage cell in the first direction and the second inner heat conduction element, the every fourth power storage cell being other than the power storage cells contacting the second outer connecting element among the power storage cells.

3. The power storage device according to claim 1, further comprising a cooler that cools the power storage cells, wherein:
the valve mounting surface is made up of a lower surface of the cell case; and
the cooler is disposed above the cell case.

4. The power storage device according to claim 1, wherein the first connecting member and the second connecting member are made of a thermally conductive adhesive.
